(19) United States
(12) Patent Application Publication
(10) Pub. No.: US 2014/0083555 A1
(43) Pub. Date: Mar. 27, 2014

(54) COMBINATION SCOOP AND FUNNEL

(71) Applicant: Jarred Loran Allen, Conroe, TX (US)

(72) Inventor: Jarred Loran Allen, Conroe, TX (US)

(21) Appl. No.: 13/919,121

(22) Filed: Jun. 17, 2013

Related U.S. Application Data
(60) Provisional application No. 61/706,014, filed on Sep. 26, 2012.
(60) Provisional application No. 61/714,550, filed on Oct. 16, 2012.

(51) Int. Cl. B67C 11/02

(52) U.S. Cl. CPC B67C 11/02
USPC 141/1; 141/331

(57) ABSTRACT

A combination scoop and funnel device is disclosed that can be used to transfer a powder material from one container to another. The combination scoop and funnel device may include a scoop portion and a funnel portion coupled together by a hinge. The funnel portion has an open position and a closed position. When the funnel portion is in the open position, the scoop portion can be used to scoop powder material from a first container. Once scooped, the funnel portion can be moved to the closed position. The device can then be inverted to pour the powder material into a second container.

### CROSS-REFERENCE TO RELATED APPLICATIONS

This application claims priority under 35 U.S.C.§119 to the following provisional applications: Ser. No. 61/706,014 filed Sep. 26, 2012 and Ser. No. 61/714,550 filed Oct. 16, 2012, which are incorporated by reference in their entirety.

### FIELD

This disclosure relates to scooping and pouring of materials. In particular, this disclosure relates to a combination scoop and funnel.

### BACKGROUND

When mixing a powder or granular material with a liquid, it is common to use a measuring cup to scoop the material and pour it into a container of water. When pouring powder into a container having a relatively small opening, such as a water bottle, it is difficult to pour the powder into the opening of the container without spilling some of the powder. There is a need for devices that make the process of pouring powdered material into a container easier and cleaner.

### SUMMARY

A combination scoop and funnel is provided including a scoop portion configured to hold a quantity of powdered material, a handle coupled to the scoop portion, a funnel portion having a first end with a size configured to match the scoop portion and a second end with a reduced size to allow powdered material to be poured into a relatively small opening, a hinge movably coupling the funnel portion to the scoop portion, and wherein the funnel portion is movable, relative to the scoop portion, between an open position and a closed position, wherein the funnel portion is moved away from the scoop portion in the in the open position to allow a user to scoop powdered material into the scoop portion, and wherein the funnel portion secured to the scoop portion in the closed position to prevent the scooped powdered material from exiting the scoop portion except through the funnel portion.

Another embodiment provides a method of pouring a powdered material from a first container to a second container, the method including providing a combination scoop and funnel having a scoop portion configured to hold a quantity of powdered material and a funnel portion configured to attach to the scoop portion, scooping a quantity of powder material from the first container using the scoop portion of the combination scoop and funnel, and pouring the quantity of powder into the second container through the funnel portion of combination scoop and funnel.

### BRIEF DESCRIPTION OF THE DRAWINGS

FIG. 1 is a perspective view of a combination scoop and funnel device.

FIG. 2 is a bottom view of the combination scoop and funnel device shown in FIG. 1.

FIG. 3A is a top view of the combination scoop and funnel device shown in FIG. 1.

FIGS. 3B-3C show top views of combination scoop and funnel devices with different handle orientations.

FIGS. 4 and 5 illustrate the combination scoop and funnel device shown in FIG. 1 in opened closed positions.

FIG. 6 is a sectional view taken along lines 6-6 of FIG. 3A.

FIG. 7 is a side view illustrating the use of a combination scoop and funnel device being used to pour powder material into a container.

FIGS. 8A-8C are side, top, and bottom views, respectively, of a plug that can be used to seal the opening of a funnel.

FIG. 9 is an exploded view of a combination scoop and funnel device and the plug shown in FIG. 8A.

FIG. 10 is a side view showing the plug inserted into the opening of the device shown in FIG. 9.

FIG. 11 is a side view of a combination scoop and funnel device having a funnel cap.

FIG. 12 illustrates another example of a combination scoop and funnel device.

FIG. 13 illustrates another example of a combination scoop and funnel device.

FIG. 14 illustrates another example of a combination scoop and funnel device.

FIGS. 15-16 illustrate another example of a combination scoop and funnel device.

### DETAILED DESCRIPTION

Generally, the present disclosure relates to a combination scoop and funnel device that can be used to transfer a powder material from one container to another. In one example, the combination scoop and funnel device includes a scoop portion and a funnel portion coupled together by a hinge. The funnel portion has an open position and a closed position. When the funnel portion is in the open position, the scoop portion can be used to scoop powder material from a first container. Once scooped, the funnel portion can be moved to the closed position and locked in place. The device can then be inverted to pour the powder material into a second container. The device may also include a handle for easier operation, and a device to seal the opening in the funnel portion after scooping the material.

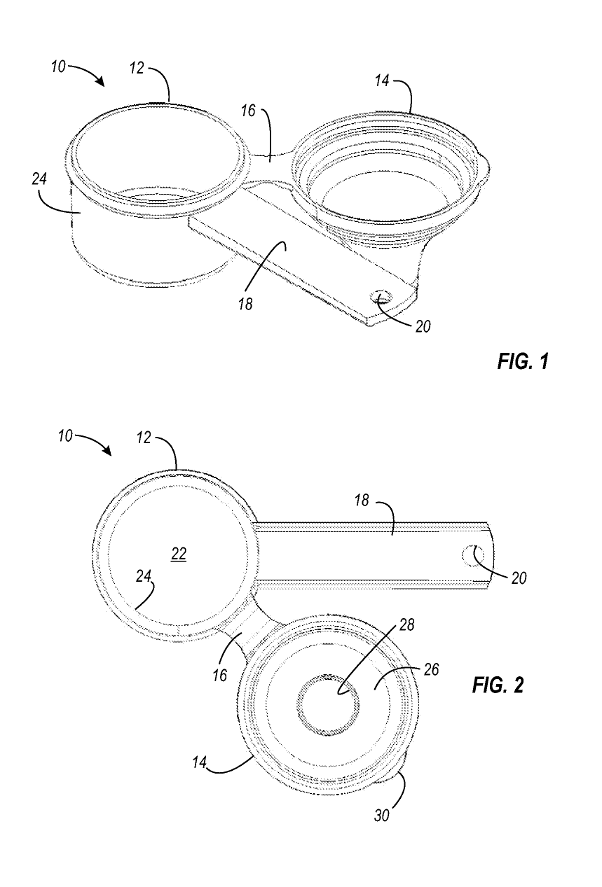

FIGS. 1-6 illustrate one example of combination scoop and funnel according to the present disclosure. FIG. 1 is a perspective view showing a combination scoop and funnel device 10. The device 10 has a scoop portion 12 coupled to a funnel portion 14 via a living hinge 16. The funnel portion 14 is movable between an open position (as shown in FIG. 1) and a closed position (described below). A handle 18 is coupled to the scoop portion 12 to enable easy use by a user. The handle 18 has an optional hole 20 formed to allow the device 10 to be hung from a hook, nail, etc. In the examples shown in FIGS. 1-6, the handle 18 is slightly concave on its upper surface to increase the strength of the handle. FIG. 2 is a bottom view of the combination scoop and funnel device 10 shown in

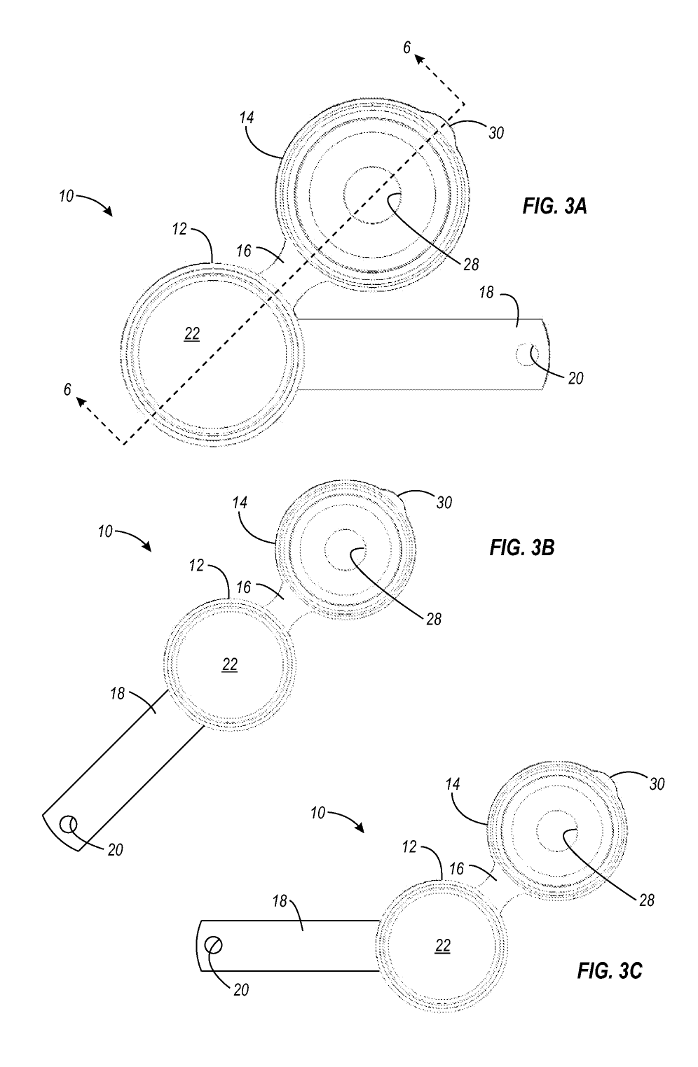

FIG. 1. FIGS. 3A-3C show top views of the combination scoop and funnel device 10, with the handle 18 is alternate orientations. The scoop portion 12 includes a bottom surface 22 and a side wall 24 forming a cylindrical cavity with an open top. The shape of the scoop portion can take any desired form, though. No matter what shape is used, the configuration of the scoop portion allows a user to use the device 10 to scoop and hold a powered material.

The funnel portion 14 includes a generally conical surface 26, extending upward toward a reduced funnel opening 28. The upper part of the side wall 24 of the scoop portion 12 and the lower part of the conical surface 26 of the funnel portion 14 are configured fit together and lock in place (described below) to hold the power material in the device 10. The funnel portion 14 also has tab 30 extending from the lower edge of the funnel portion 14 opposite the hinge 16. The tab 30 gives a user something to press when the user wishes to open the device 10.

FIGS. 3A, 3B, and 3C show three exemplary positions of the handle 18, relative to the funnel portion 14 and hinge 16. The handle 18 may be formed at any desired position.

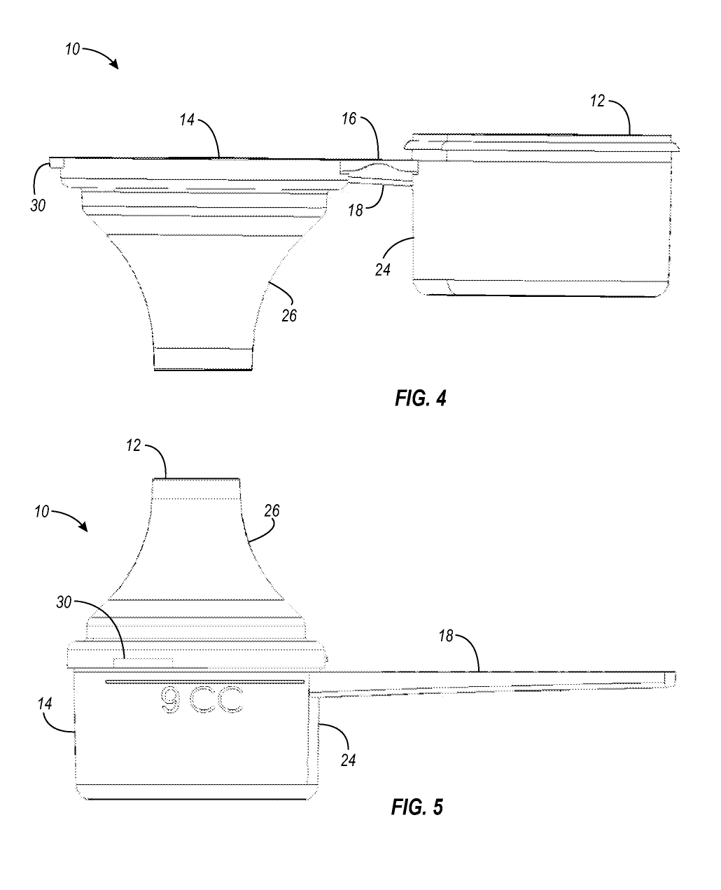

FIGS. 4 and 5 illustrate the combination scoop and funnel device 10 in the open position (FIG. 4) and the closed position (FIG. 5). The view shown in FIG. 4 is similar to the views shown in FIGS. 1-3. In FIG. 5, the funnel portion 14 is moved to the closed position, for example, after a user has scooped a powder material into the scoop portion 12. In the closed position, the material is enclosed within the device 10 until the user tilts the device 10 to pour the material into a container. FIG. 5 also illustrates an optional volume indicator formed on the side wall 24. In this example, a line is formed at a level corresponding to a specific volume (in this example, 9 cubic centimeters). In other examples, multiple indicator lines can be formed. Also note that the device 10 can be designed to hold any desired volume.

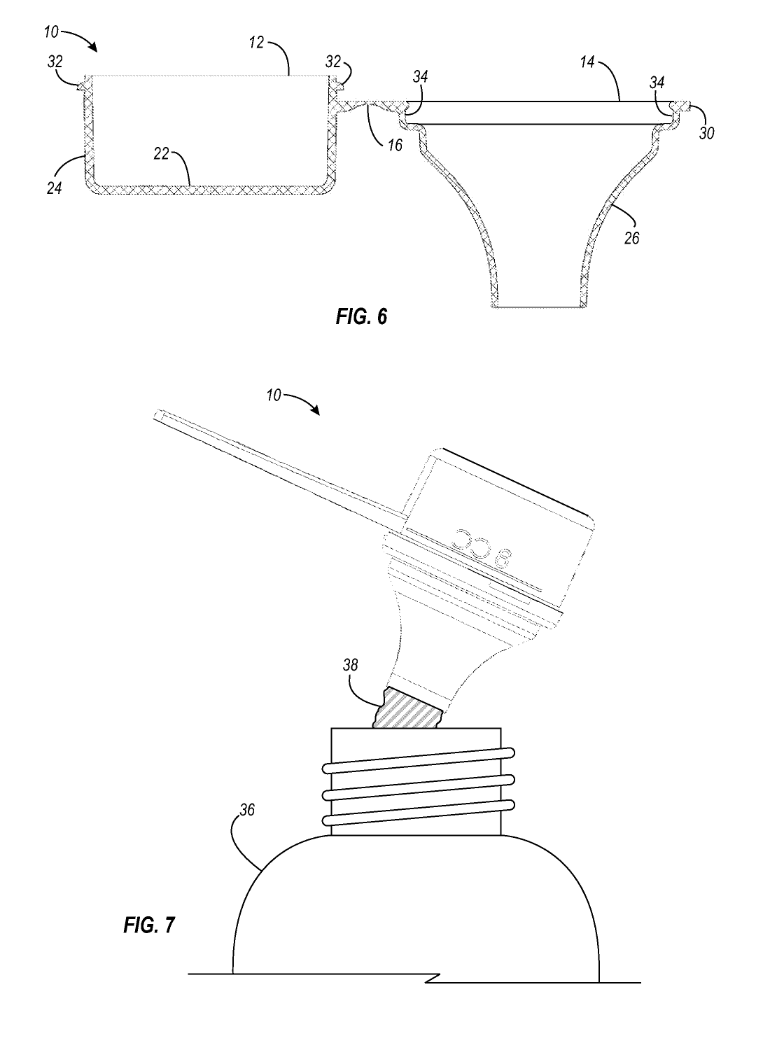

FIG. 6 is a sectional view taken along lines 6-6 of FIG. 3A, illustrating various structural details of the example shown in FIGS. 1-5. In this example, the combination scoop and funnel device 10 is made from a single blow molded piece of plastic material. FIG. 6 also shows structural details of the hinge 16. As shown, the hinge 16 is a living hinge and couples the scoop portion 12 and the funnel portion 14 together. The hinge 16 has a middle portion with a reduced thickness, which helps control where the hinge bends to help align the funnel portion 14 with the scoop portion 12, as well as making the hinge bend easier and keep the device in the closed position. In other examples, the hinge can be comprised of a mechanical hinge (described below). In another example, the scoop portion 12 and funnel portion 14 are separate pieces (with no hinge) that are snapped together when needed.

FIG. 6 also illustrates details of the mechanism used to lock the device 10 in the closed position. In this example, the scoop portion 12 has an annular protrusion 32 formed around the outside of the wall 24. The funnel portion 14 has a mating annular groove 34. When a user moves the device 10 to the closed position (FIG. 5) and pressed downward, the annular protrusion 32 is forced into the annular groove 34, locking the device in the closed position until the user applies an upward force to the tab 30 to open the device. Note that other ways of securing the device in the closed position can also be used.

FIG. 7 is a side view illustrating the use of a combination scoop and funnel device 10 being used to pour powder material into a container, such as a bottle 36. When a user of the device 10 wishes to mix a powder 38 with water contained in a bottle 36, the user will scoop some powder into the scoop portion 12. Once the powder is scooped, the device can be closed (FIG. 5) to contain the powder within the device. The user then tilts the device 10, and the powder 38 will move through the opening 28 of the funnel portion 14 and through the opening of the bottle 36.

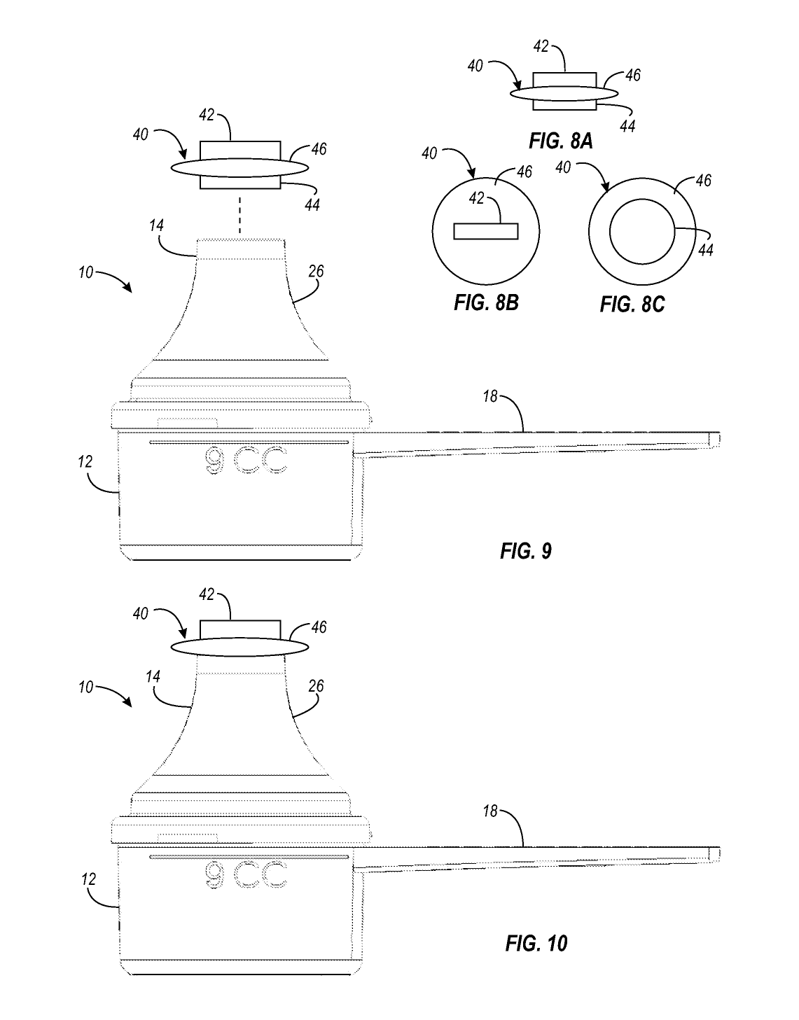

In some instances, it may be desirable to seal the combination scoop and funnel device 10 after scooping the powder material. FIGS. 8A-8C are side, top, and bottom views, respectively, of a plug 40 that can be used to seal the opening 28 of the funnel portion 14. The plug 40 has a handle 42 that can be grasped by a user. A cylindrical lower portion 44 is sized to fit snuggly within the opening 28 of the funnel portion 14 when pressed in by a user. A middle portion 46 prevents the plug 40 from being pressed all the way through the opening 28.

FIG. 9 is an exploded view of a combination scoop and funnel device 10 and a plug 40. FIG. 10 is a view showing the plug 40 inserted into the opening 28, sealing the powder within the device 10. Prior to pouring the powder from the device 10, a user can grasp the handle 42 and pull the plug 40 from the opening 28. While FIGS. 8A-10 show the plug 40 as a separate piece, in other examples the plug 40 can be tethered to the device 10, so it will not get lost.

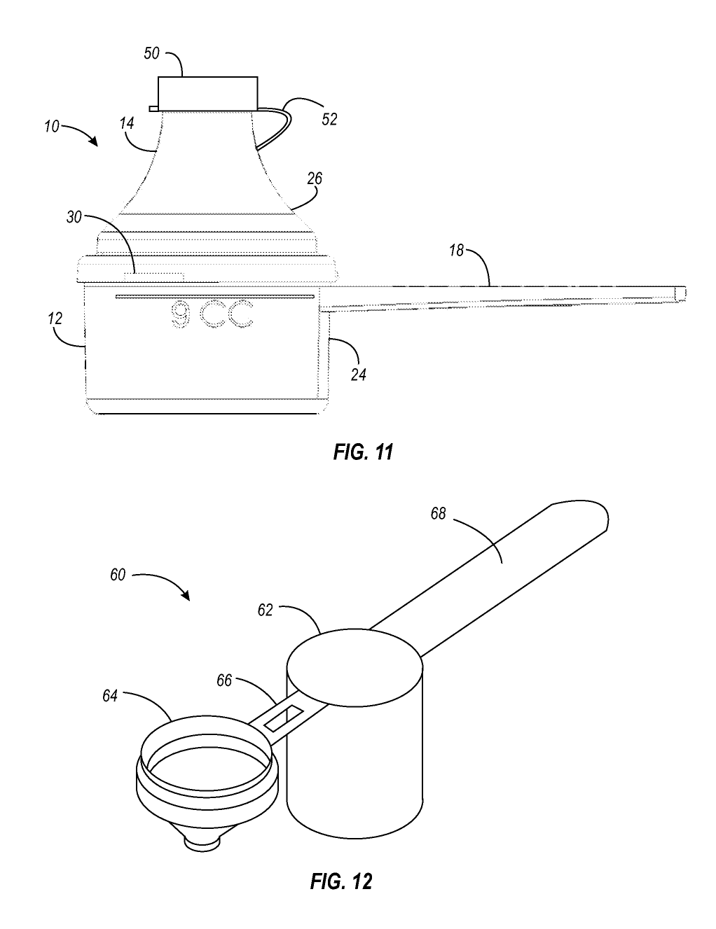

FIG. 11 is a view of another example of a combination scoop and funnel device 10 that can be sealed. In this example, a flip top cap 50 is configured to attach to the top of the funnel portion 14. A tether 52 couples the cap 50 to the device 10.

FIG. 12 illustrates another example of a combination scoop and funnel device 60 according to the present disclosure. The device 60 has a scoop portion 62 coupled to a funnel portion 64 via a living hinge 66. The funnel portion 64 is movable between an open position (as shown in FIG. 12) and a closed position. A handle 68 is coupled to the scoop portion 62 to enable easy use by a user. In general, the device 60 operates in the same manner as the device 10 described above.

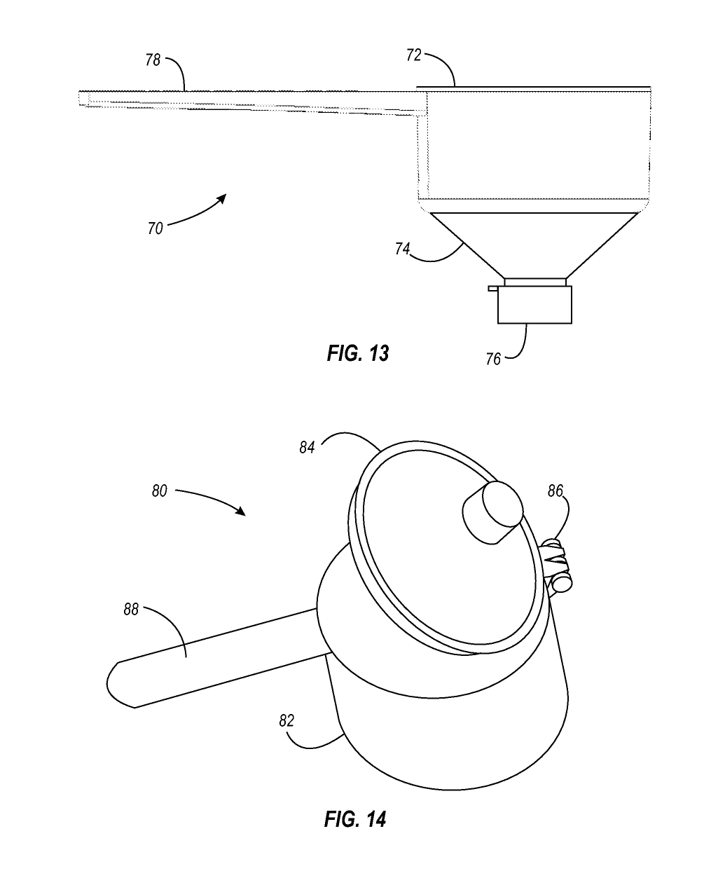

FIG. 13 illustrates another example of a combination scoop and funnel device 70 according to the present disclosure. The device 70 has a scoop 72 having a bottom portion forming a funnel 74. A cap 76 seals the device 70 while scooping powder. When a user pours the powder out, the cap 76 is removed, allowing the powder to flow through the funnel 74. If desired, the cap 76 can be tethered to the funnel 74. A handle 78 is coupled to the device 79 to enable easy use by a user.

FIG. 14 illustrates another example of a combination scoop and funnel device 80 according to the present disclosure. The device 80 has a scoop portion 82 coupled to a funnel portion 84 via a mechanical hinge 86. The funnel portion 84 is movable between an open position and a closed position. In the view shown in FIG. 14, the funnel portion 84 is positioned in a partially opened position. A handle 88 is coupled to the scoop portion 82 to enable easy use by a user. In general, the device 80 operates in the same manner as the device 10 described above.

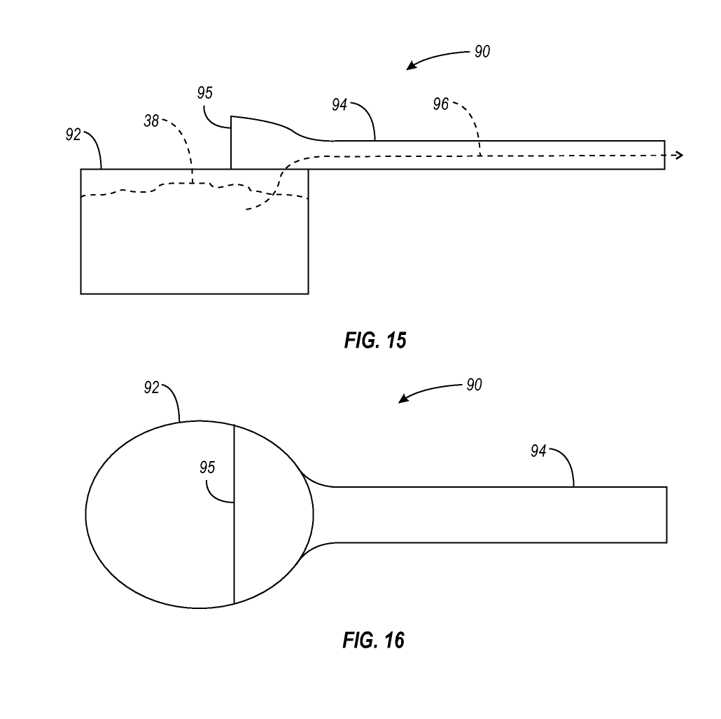

FIGS. 15-16 illustrate another example of a combination scoop and funnel device 90 according to the present disclosure. FIG. 15 is a side view of the device 90. FIG. 16 is a top view of the device 90. The device 90 has a scoop portion 92 coupled to a handle/funnel portion 94. The handle/funnel portion 94 is comprised of an elongated hollow handle that provides a communication path between the interior of the scoop portion 92 and the opposite end of the handle/funnel portion 94. The handle/funnel portion has a top edge 95 that can be positioned such that all of the scooped material will be held in the funnel when the user turns the device 90 upright. A user can grasp the handle/funnel portion 94 and scoop powder 38 (illustrated with hidden lines in FIG. 15) into the device 90. When the user tilts the handle end of the device 90 downward, the powder 38 will flow through the hollow handle/funnel portion 94, as illustrated by the arrow 96 shown in FIG. 15.

The combination scoop and funnel devices described above can be used to scoop and pour any desired material, for example, fitness supplements, baby formula, bird seed, kitchen supplies such as sugar and flour, etc. The devices can also be used as measuring devices, where a user can easily scoop and pour a desired amount of material. The devices described can also be configured to hold any desired volume of material.

What is claimed is:

1. A combination scoop and funnel comprising:
a scoop portion configured to hold a quantity of powdered material;
a handle coupled to the scoop portion;
a funnel portion having a first end with a size configured to match the scoop portion and a second end with a reduced size to allow powdered material to be poured into a relatively small opening;
a hinge movably coupling the funnel portion to the scoop portion; and
wherein the funnel portion is movable, relative to the scoop portion, between an open position and a closed position, wherein the funnel portion is moved away from the scoop portion in the in the open position to allow a user to scoop powdered material into the scoop portion, and wherein the funnel portion secured to the scoop portion in the closed position to prevent the scooped powdered material from exiting the scoop portion except through the funnel portion.

2. The combination scoop and funnel of claim 1, further comprising:
an annular protrusion extending outward from the scoop portion; and
a mating annular groove formed on the inside surface of the funnel portion, wherein the annular protrusion and mating annular groove are configured to secure the funnel portion in the closed position when the annular protrusion is disposed in the annular groove.

3. The combination scoop and funnel of claim 1, further comprising a tab extending outward from the funnel portion to enable a user to move the funnel portion by applying force to the tab.

4. The combination scoop and funnel of claim 1, wherein the hinge is a living hinge.

5. The combination scoop and funnel of claim 4, wherein the living hinge has a middle portion with a reduced thickness, relative to the remainder of the living hinge.

6. The combination scoop and funnel of claim 1, wherein the hinge is a mechanical hinge.

7. The combination scoop and funnel of claim 1, further comprising a plug configured to seal the funnel portion by plugging the second end of the funnel portion.

8. The combination scoop and funnel of claim 7, wherein the plug includes a handle extending from the plug.

9. The combination scoop and funnel of claim 1, further comprising a cap configured to fit over the second end of the funnel portion.

10. The combination scoop and funnel of claim 9, further comprising a tether coupled between the cap and the combination scoop and funnel.

11. A method of pouring a powdered material from a first container to a second container, the method comprising:
providing a combination scoop and funnel having a scoop portion configured to hold a quantity of powdered material and a funnel portion configured to attach to the scoop portion;
scooping a quantity of powder material from the first container using the scoop portion of the combination scoop and funnel; and
pouring the quantity of powder into the second container through the funnel portion of combination scoop and funnel.

12. The method of claim 11, wherein the scoop portion and the funnel portion are coupled together by a hinge.

13. The method of claim 12, wherein the hinge is a living hinge.

14. The method of claim 12, wherein the hinge is a mechanical hinge.

15. The method of claim 12, further comprising attaching the funnel portion to the scoop portion after scooping the quantity of powder material from the first container.

16. The method of claim 15, further comprising securing the funnel portion to the scoop portion by forcing an annular protrusion formed on the scoop portion into an annular groove formed on the funnel portion.

17. The method of claim 11, further comprising inserting a plug into the funnel portion after scooping the quantity of powder material from the first container to seal the scooped powder material within the combination scoop and funnel.

18. The method of claim 17, further comprising removing the plug prior to pouring the quantity of powder into the second container.

19. The method of claim 11, wherein the scoop portion forms a cylindrical cavity having an open top and an open bottom, and wherein the funnel portion is disposed between the open bottom of the cylindrical cavity and an funnel opening having a diameter smaller than the open bottom.

20. The method of claim 19, further comprising placing a cap over the funnel opening prior to scooping the quantity of powder material from the first container.
